(19) United States
(12) Patent Application Publication
(10) Pub. No.: US 2025/0131491 A1
(43) Pub. Date: Apr. 24, 2025

(54) PREDICTIVE SPENDING AND PAYMENT MANAGEMENT SYSTEMS AND METHODS

(71) Applicant: American Express Travel Related Services Company, Inc., New York, NY (US)

(72) Inventors: Rajendra Prasad Modadugu, Weston, FL (US); Manjunath B. Devadi, Weston, FL (US); Jyothsna Nayak, Weston, FL (US)

(21) Appl. No.: 18/492,390

(22) Filed: Oct. 23, 2023

(51) Int. Cl. G06Q 40/02

(52) U.S. Cl. CPC G06Q 40/02

(57) ABSTRACT

Disclosed are various approaches for managing payment variability by developing a schedule of monthly payments. An exemplary method of the present disclosure comprises predicting, using an eligibility data model, a level of volatility of spending for a user based on at least transaction data and transaction account balance data of the user during a previous year; predicting, using a balance prediction data model, a future spend behavior for the user during an upcoming period of time, wherein the upcoming period of time comprises a plurality of months; generating a monthly payment schedule for the user for the upcoming period of time based on the predicted future spend behavior of the user; and for each month of the upcoming period of the time, issuing a monthly payment statement to the user based on the generated monthly payment schedule. Other methods, systems, and computer-readable mediums are also presented.

### BACKGROUND

It is common for persons to incur expenses during the same monthly periods from year to year, such as around work or school events and/or holidays. For example, a person or family can plan for a trip during Thanksgiving or can purchase new clothes in advance of starting a new school year. Accordingly, such periodic events can result in a level of spending variability (or lack of consistency) in the spending pattern or behavior of the user and a level of payment variability on their monthly billing/account statements to financial institutions. Thus, there is a need for planning tools to allow for such spending patterns to be anticipated and for proactive payment plans to be implemented.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows an illustrative example of a customer average spend per month for a hypothetical user.

FIG. 2 gives an overview of an exemplary embodiment of a predictive spending and payment management system of the present disclosure.

FIG. 3 is a block diagram demonstrating the generation of eligibility and balance prediction data models from various data sources in accordance with embodiments of the present disclosure.

FIG. 4 is a flow chart illustrating an exemplary method that can be implemented by a predictive spending and payment management system described with reference to FIG. 2.

FIG. 5 is a flow chart illustrating an exemplary billing and account statement method that can be implemented by a predictive spending and payment management system described with reference to FIG. 2

FIG. 6 is a flow chart illustrating an exemplary billing and payment deferral method that can be implemented by a predictive spending and payment management system described with reference to FIG. 2.

FIG. 7 is a flow chart illustrating an exemplary training method for an eligibility model and/or a balance prediction model that can be implemented by a predictive spending and payment management system described with reference to FIG. 3.

FIG. 8 is a flow chart illustrating an exemplary method for a predictive spending and payment management system described with reference to FIG. 3.

### DETAILED DESCRIPTION

Disclosed are various approaches for managing payment variability by devising a schedule of payments to account for predicted spending patterns of users of a transaction account issuer that occur periodically over time. By evaluating the historical spend patterns of a user, structures or patterns in the historical spending behavior of the user can be identified and used to predict the spending behavior of the user during a set period (e.g., a 12 month period). Accordingly, based on the predicted spending behavior, a payment plan can be developed, using one or more data models, at the beginning of the period and can account for and offset spikes and variability in a predicted spending behavior of the user, such that monthly payments within the payment plan are balanced and are known in advance by the user. In this way, the user will not have large swings in the amount they owe from month to month. Accordingly, systems and methods of the present disclosure can provide a regular structure to the payment plan of a user, which allows for the user to have better control over planning and making payments on a month to month basis.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

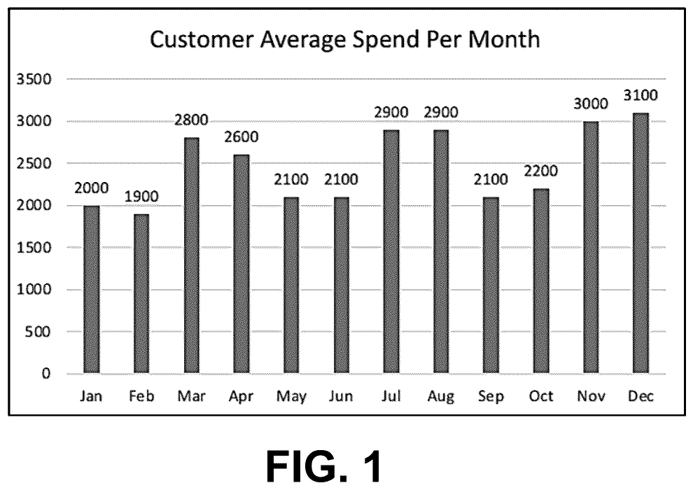

FIG. 1 shows an illustrative example of a customer average spend per month for a hypothetical user. In FIG. 1, the user has fluctuating monthly spend or variability with respect to a user's transaction account, where a user device receives a monthly bill from the transaction account issuer and is expected to provide a monthly bill payment to reimburse the transaction account issuer for the monthly spend amount. Here, the user monthly spend amounts fluctuate between $1,900 and $3,100 dollars per month.

In accordance with systems and methods of the present disclosure, the historical spend patterns of the user can be evaluated over a set period (e.g., 12 month period) in order to predict the spending patterns of the user during a subsequent period and produce a payment plan that anticipates variability in the spending habits of the user. For example, based on the historical spending habits presented in FIG. 1, a hypothetical month-to-month payment plan can be offered to the user at $2,500 per month for the first four months of the year, $2,400 per month for the second four months of the year, and $2, 100 per month for the last four months of the year, irrespective of how much the actual monthly spend is, which provides a structured plan for the user.

In this non-limiting example, there is one monthly payment amount set for the first four months, a second monthly payment amount set for the second four months, and so on. However, in various embodiments, the particular grouping of months can be determined based on a historical spending pattern in any combination, such that the same payment amount can be due across each month of a set period (e.g., 12 month period) in one non-limiting example, or a first monthly payment amount can be for each of the first two months of the year and a second monthly payment amount can be due for the next five months of the year and a third monthly payment can be due for the last five months of the year in a second non-limiting example; and so on. This will give the user the ability to better plan their monthly budget and decrease spikes or large increases in the user's monthly balance for future expenses. At the same time, the spending and payment behavior of the user can be monitored and evaluated to determine if the payment schedule should be adjusted or if the user should be removed from the payment plan if the user's spending behavior does not conform to the predicted spending behavior, such as within a set margin of error, where the margin of error is a statistical measurement that accounts for a difference between actual spending behavior and the predicted spending behavior. As an example, a user's actual spending behavior that matches or follows a predicted spending behavior within a 5% (or some other set value) margin of error or less may be considered to conform to the predicted spending behavior, whereas an actual spending behavior that has a margin of error greater than 5% (or some other set value) may be considered to not conform to the predicted spending behavior.

Additionally, in various embodiments, the payment plan can be integrated into a savings accounts or a contractual deposits arrangement with the transaction account issuer (or other financial institution) to route deferred funds (e.g., an excess payment amount that is more than a scheduled monthly payment or is more than a current transaction account balance) into an account for the user where interest can be paid by the financial institution and the funds will be available to cover potential unanticipated or unplanned expenses.

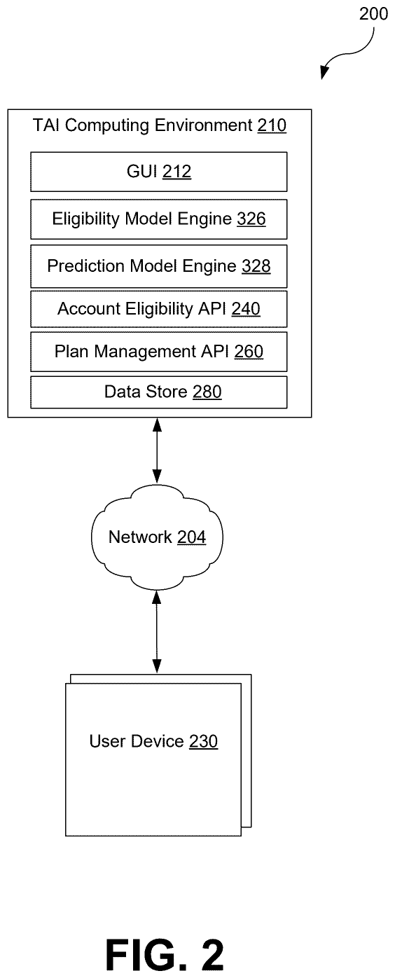

FIG. 2 gives an overview of an exemplary embodiment of a predictive spending and payment management system 200 of the present disclosure. The predictive spending and payment management system 200 is designed to model the spending behavior of a user based on at least historical spending and payment patterns (e.g., transaction data, balance data, etc.) of the user and identify if the user is eligible to participate in a payment plan. To understand the user's spending behavior, other user data can also be input in the model, such as, but not limited to, user demographic data (e.g., age, gender, residential location, etc.), user linked accounts, user relationships, balance, demographic data of the user, etc. The predictive spending and payment management system can then predict the future spending patterns of the user for a subsequent period (e.g., 12 month period, 24 month period, etc.) and establish a payment plan that is offered to the user to account for the predicted spending pattern of the user.

Referring to FIG. 2, the system 200 can comprise a transaction account issuer (“TAI”) computing environment 210. The TAI computing environment 210 can comprise one or more servers and/or databases, such as data store 280, which store information relevant to a user, such as transaction history, payment plan information, eligibility data, transaction account balance data, credit scores, user demographics, linked accounts, user relationships, etc. The data store 280 can be located in a single installation or can be distributed among many different geographical locations. The TAI computing environment 210 can communicate using a network 204 in order to provide account information to the user and process payments from the user.

The TAI computing environment 210 can provide a graphical user interface (“GUI”) 212, such as a web site or mobile application, which allows a user to interact with the TAI. For example, the TAI computing environment 210 can provide a website which allows the user to view account statements and make payments.

The user can interact with the system 200 utilizing one or more user devices. User device 230 can comprise any device capable of communicating over a network and/or communicating content. For example, user device 230 can take the form of a computer or processor, or a set of computers/processors, such as a computer, laptop, notebook, hand held computer, personal digital assistant, cellular phone, smart phone (e.g., iPhone®, BlackBerry®, Android®, etc.), tablet, wearable (e.g., smart watch and smart glasses), automotive infotainment system, or any other suitable device having user interaction capabilities or dialog capabilities. User device 230 can be in electronic communication with network 204.

The user can use a user device 230 to view account statements, make payments, and otherwise perform transaction account functions. The user device 230 can interact with TAI computing environment 210 in order for the user to make payments to the transaction account. In various embodiments, the user device 230 can comprise a mobile application, and the user can open the mobile application to interface with the TAI computing environment 210. In various embodiments, the user device 230 can comprise a touch screen interface, such that the user or other consumers can interact with the GUI by contacting the touch screen interface.

The system 200 can present users with options for scheduled payment plans. In various embodiments, the system 200 can present the scheduled payment plan options in real time in response to a user opening or logging into an application or website, or calling the TAI on the phone. The TAI computing environment 210 can utilize one or more application programming interfaces (API) to create and manage fixed scheduled payment plans.

An account eligibility API 240 can determine whether a user's account for a transaction account issuer (e.g., a user's credit card account) is eligible for a scheduled payment plan based on a data model prepared by an eligibility model engine 326. For example, the account eligibility API 240 can obtain eligibility data from the data store 280 that is generated by the eligibility model engine 326. The eligibility data can indicate whether the consumer is eligible for a scheduled payment plan. The eligibility data can indicate a schedule of monthly payments for the scheduled payment plan for the user that is generated using a data model prepared by a prediction model engine 328. For example, the eligibility data can indicate that the user is scheduled to make a payment of $2,000 per month for January through March; make a payment of $1,500 for April through July; a payment of $1,700 for August through October; and a payment of $1,900 for November through December during a current or future annual period.

If the user selects and enrolls in a scheduled payment program/plan, a plan management API 260 can control repayment rules for the transaction account of the user. For example, in response to receiving a payment from the user, the plan management API 260 can compare the monthly payment amount under the scheduled payment plan with the actual spending amount of the user, and record & document an excess in payment over the spending amount (e.g., the user paid $2,000 in accordance with the scheduled payment plan, where the spending amount for the corresponding amount is $1,500, resulting in an excess payment of $500). For any excess payment, the plan management API 260 can deposit the excess payment in a savings accounts/contractual deposits arrangement with the transaction account issuer (or other financial institution) to route deferred funds into the savings account of the user where interest can be paid by the financial institution and the funds will be available to cover potential unanticipated/unplanned expenses and underpayments in other monthly periods. Thus, the plan management API 260 can also record & document a shortage in payment over the actual spending amount for a particular monthly period (e.g., the user paid $2,000 in accordance with the scheduled payment plan, where the spending amount for the corresponding amount is $2,300, resulting in a shortage of $300). In this case, where the user has available funds in the savings account, the funds can be used to cover or offset the $300 shortage and the savings account balance will be adjusted (e.g., if the user has a $300 shortage and has $500 in their savings account, then $300 of the savings will used to make up the $300 shortage and $200 will remain in the savings account balance). If the user pays the scheduled monthly balance of the scheduled payment plan, the user will not be charged any monthly finance charge as long as the user continues to make the aforementioned payment in subsequent statement periods and there is no outstanding shortage at the end of the annual period.

Network 204 can be an electronic communication system accomplishing communication among the parties through any suitable communication channels, such as, for example, a telephone network, an extranet, an intranet, Internet, online communications, satellite communications, off-line communications, wireless communications, transponder communications, local area network (LAN), wide area network (WAN), virtual private network (VPN), networked or linked devices, and/or any suitable communication modality. Moreover, although the system can be described herein as being implemented with TCP/IP communications protocols, the system can also be implemented using IPX, Appletalk, IP-6, NetBIOS, OSI, any tunneling protocol (e.g. IPsec, SSH), or any number of existing or future protocols. If the network is in the nature of a public network, such as the Internet, it can be advantageous to presume the network to be insecure and open to eavesdroppers. Specific information related to the protocols, standards, and application software utilized in connection with the Internet is generally known to those skilled in the art and, as such, need not be detailed herein.

In various embodiments, TAI computing environment 210 and other system components are in electronic communication with network 204. In that regard, TAI computing environment 210 can communicate scheduled payment plans and/or offerings to user devices 202. The servers operated by and/or associated with TAI computing environment 210 can be, for example, processors, computers, web servers, and/or backend servers configured to generate content and transmit the content to user devices. Users can log into an account using known security means to authenticate a user and tailor content specifically for the authenticated user.

TAI computing environment 210 can be maintained by a transaction account issuer using, for example, a distributed computing cluster. The distributed computing cluster can comprise a plurality of computing nodes configured for parallel processing and storage. In that regard, processing and storage tasks can be split among the nodes of the distributed computing cluster to improve throughput and enhance storage capacity. TAI computing environment 210 can be maintained on a distributed system configured to process and store big data sets with some of the nodes comprising a distributed file system and some of the nodes comprising a distributed processing system.

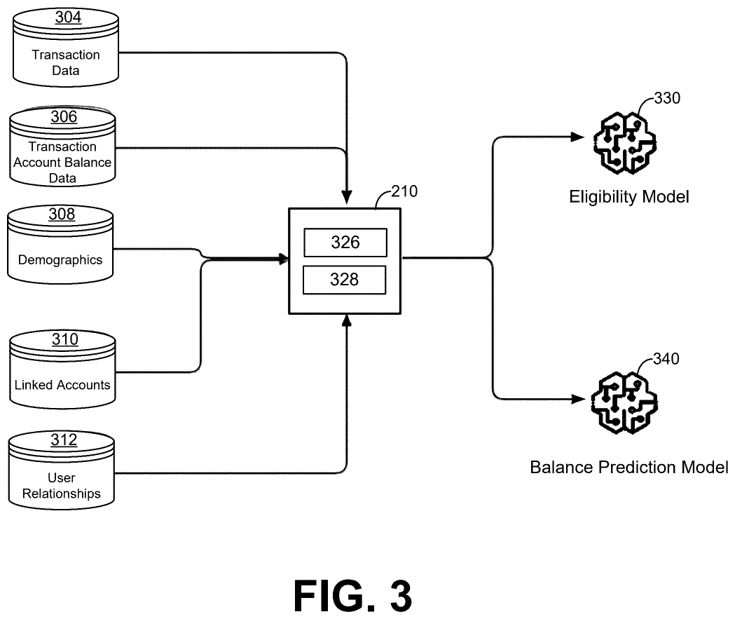

Referring now to FIG. 3, in various embodiments, data from various data sources can be collected and stored in a file system of the TAI computing environment 210 (e.g., a distributed system in a Hadoop® cluster). Accordingly, the block diagram of FIG. 3 demonstrates the generation of data models from various data sources. In accordance with various embodiments of the present disclosure, eligibility and balance prediction data models 330, 340 are built and executed to identify if a user fits into a scheduled payment plan/program of a transaction account issuer.

Data sources ingested into file system can include transaction data 304, transaction account balance data 306, user or customer demographic data 308, linked accounts 310, user or customer relationships 312, and other suitable data for generating the applicable data models, such as, but not limited to, third party data, public data, click streams, etc. The data can be stored in suitable big data formats for subsequent mapping to help reduce processing.

In various embodiments, transaction data 304 can include years of user or consumer transaction data for United States (US) and global markets stored in a secure area. Transaction data 304 can detail each transaction executed using each transaction account maintained by a transaction account provider based on, for example, record of charges (ROC) data. Transaction account balance data 306 can include a history of account balances of a transaction account or related accounts of users of the transaction account issuer. Demographics data 308 can include history of consumer demographic and account information for the transaction accounts maintained by a transaction account provider. Linked accounts data 310 can include user financial accounts, such as a checking account, which are linked to the transaction account. User relationships data 312 can include information on other transaction account users that maintain a personal or business relationship with a transaction account user. Other suitable data can also be included, such as third-party data and public data. For example, third party data can include additional data which is obtained or purchased from third parties. Third party data can include third party data products made available by third party providers. Public data can include data that is publicly available and ready to use. Public data can be free or subscription-based. Examples of public data include data available from social media sites (e.g., Facebook® and Twitter®), government sources, or other publicly available data sources.

TAI computing environment 210 can maintain the data to support a computational framework that includes an eligibility model engine 326, balance prediction model engine 328, and other suitable data computation services. Eligibility model engine 326 can provide data aggregation and transformation to support a user eligibility model 330. For example, raw data transformations can generate rollup data on a per-user basis. Rollup data can thus summarize the transaction history of transaction accounts.

In various embodiments, the eligibility model 330 can leverage historical transaction data to create user-to-user similarity or lookalike metrics based on user transaction data using collaborative filtering and custom algorithms. Thus, certain transaction data (or other types of user data, such as a user's interests, demographics, etc.) can be associated with certain categories that are used as a basis for predicting the user's spending variability and/or determining a balance prediction. Thus, such user data can also be related to other users with similar types of user data in order to create a user profile, while the other users' data can be used as a reference in making user predictions. In various embodiments, similarity metrics measure users relative to one another in various segments. Users can be characterized based on available associated information. Where closed-loop data (e.g., transaction history and/or ROC data) is available for a user, the closed-loop data can be used to generate spending scores for the user against certain spending volatility levels (e.g., low spending volatility, medium spending volatility, high volatility). If desired, the closed-loop data can be used in conjunction with third party data, public data, or feedback to generate the scores. The closed-loop data can include, for example, spend pattern, type of merchants visited, travel preferences, interests, spend frequency, and demographics. Third party and public data can include demographics, home location, and/or other information, but cannot include closed-loop data such as transaction history. The scores can be integrated into a user vector for comparison with other users.

In various embodiments, TAI computing environment 210 (e.g., balance prediction model engine 328) can further generate balance prediction model 340. Balance prediction model 340 can be generated using users' historical transaction data (e.g., data captured in ROCs). Balance prediction model 340 can predict a user's spending patterns or behaviors and resulting transaction account balance over a specific period of time (e.g., an annual period) based on historical spends. Thus, the balance prediction model assesses factors which can influence a user's ability to make payments to the transaction account issuer by identifying user transactions and relationships (e.g., business and/or personal relationships) to determine if the user payment history is predictable and follows a certain structure that can be used to develop an appropriate and ongoing payment plan for the upcoming year (or other period of time).

For the eligibility model 330, a user spend structure and profile preferences are analyzed to identify if the user has a predictable spend structure. In various embodiments, the spending behavior of the user can be categorized as falling into a certain level of spending variability, (e.g., such as categorizing the user's spend structure into a low, medium, or high level of variability, where a high variability corresponds to low predictability and vice versa). Accordingly, in various embodiments, users that fit in the low volatility category can be eligible to be offered a scheduled payment plan for the upcoming year (or other set period of time). In various embodiments, a volatility of the spending behavior can be scored and compared to a threshold value or level, where users having spending volatility scores below a set threshold value can be offered a scheduled payment plan. For users that agree to be enrolled into the scheduled payment program/plan, the eligibility model will monitor the spending behavior of the user going forward to determine if the user's actual spending volatility is below the threshold value (e.g., if the user's behavior fits into the low volatility category). For example, a hypothetical user can have a high level of purchases using their transaction account for a certain month that far exceeds a typical purchasing or spending level for the user. In this case, the user has a high spending variability for that month in comparison to a “normal” month for the user. However, if the user regularly has a high spending variability for this certain month in previous years, then this spending variability is predictable and can be considered to fit within a low volatility category of spending. On the other hand, if the user does not regularly have a high spending variability for this certain month in their history, then this spending variability could not have been predicted and can be considered to fit within a high volatility category of spending for the user. In this case, the eligibility model engine 326 can trigger an alert signal or message when a user with a high variance of spending is not conforming with the predicted spending behavior for the user, such that the TAI computing environment 210 can then unenroll the user from the scheduled payment program/plan.

For the balance prediction model 340, the balance prediction model engine 328 generates the schedule of monthly payments for a user based on the user/customer spend (e.g., how much the user has spent) over one or more previous years and/or the nature of their expenses. In various embodiments, the range of fixed payments can span from 2 to 12 months (e.g., a hypothetical month-to-month payment plan can be offered to the user at $2500 per month for the first four months of the year, $2400 per month for the second four months of the year, and $2100 per month for the last four months of the year). Based on the user spend from month to month, the balance prediction model 340 can be re-executed to evaluate a future payment structure/schedule for the user and the new payment structure/schedule can be offered to the user for a new enrollment period.

For example, the eligibility model 330 can include a digitally constructed model that predicts a variability level of a user's spending behavior during a defined period of time (e.g., upcoming 12-month period). Correspondingly, the balance prediction model can include a digitally constructed model that predicts a monthly payment schedule that will cover a user's actual spending during a defined period of time (e.g., upcoming 12-month period). In this context, each model refers to an electronic digitally stored set of executable instructions and data values, associated with one another, which are capable of receiving and responding to a programmatic or other digital call, invocation, or request for resolution based upon specified input values, to yield one or more stored output values that can serve as the basis of computer-implemented recommendations, output data displays, or machine control, among other things.

In some embodiments, the eligibility model 330 and/or the balance prediction model 340 divides a population or data points into different groups to produce a collection of data points based on similarity and dissimilarity features between such data points. Data points in the same groups are more like other data points in the same group and dissimilar to the data points in other groups. In some implementations the eligibility model 330 and/or the balance prediction model 340 can utilize a k-means technique or other suitable clustering technique. In some implementations, the customer eligibility model 330 and/or the balance prediction model 340 can be a clustering model that: a) defines different groups to use and randomly initializes their respective center points; b) classifies or scores each data point by computing the distance between that data point and each group center, and then classify the point to be in the group whose center is closest to it; and c) re-computes the group center based on these classified points by taking the mean of all the vectors in the group. This process can be repeated for a set number of iterations or until the group centers does not change much between iterations.

In some embodiments, the eligibility model 330 and/or the balance prediction model 340 isolate data points by randomly selecting a feature and then randomly selecting a split value between the maximum and minimum values of the selected feature. The eligibility model 330 and/or the balance prediction model 340 can isolate anomaly observations or data points, in some instances, an anomaly score can be calculated as the number of conditions required to separate a given data point. In some implementations, the eligibility model 330 and/or the balance prediction model 340 can be an isolation forest model that can separate data points by first building isolation trees, or random decision trees. Then, a score can be calculated as the path length to isolate the data point.

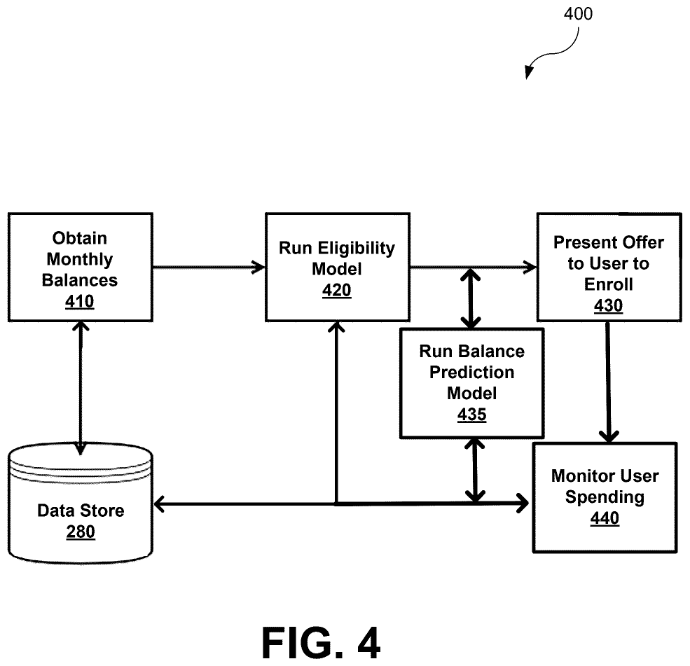

FIG. 4 is a flow chart illustrating an exemplary method 400 that can be implemented by a predictive spending and payment management system 200 described with reference to FIG. 2. For example, the exemplary method includes acquiring or obtaining (410) monthly balances for a transaction account of a user by the TAI computing environment 210 (e.g., account eligibility API 240 deployed by the TAI computing environment 210). Accordingly, the monthly balance information can be retrieved from a data store 280, which stores information procured by a transaction account issuer that is relevant to a user of the transaction account issuer, such as transaction history, transaction account balances, credit scores, user demographics, linked accounts, user relationships, payment plan information, etc. The data store 280 can be located in a single installation or can be distributed among many different geographical locations.

The exemplary method then models (420) a probability that determines a level of volatile spending behavior that has been observed for the user by the TAI computing environment 210 (e.g., eligibility model engine 326 deployed on the TAI computing environment 210). For such an eligibility model 330, a user spend structure and profile preferences are analyzed, by the TAI computing environment 210 (e.g., eligibility model engine 326 of the TAI computing environment 210), to identify if the user has a predictable spend structure. For instance, apart from a user's spending patterns, a user's interest in potentially risky ventures can contribute to having a high level of volatility. While a user can have a history of placing and winning a large majority of legal sports gambling wagers, this type of behavior can be generally regarded as being highly volatile (or highly unpredictable and/or risky) regardless of the positive monetary results that the user can receive. Accordingly, in various embodiments, the spending behavior of the user can be categorized as fitting or falling into a certain level of spending volatility, (e.g., such as categorizing the user's spend structure into a low, medium, or high level of volatility, where a high volatility corresponds to low predictability and vice versa).

Thus, in various embodiments, users that fit in the low category can be presented with an offer (430) to enroll in a scheduled payment plan for the upcoming year (or other set period of time) by the TAI computing environment 210 (e.g., account eligibility API 240 deployed by the TAI computing environment 210). In various embodiments, a volatility of the spending behavior can be scored and compared to a threshold value by the TAI computing environment 210, where users having spending volatility scores below a set threshold value can be offered a scheduled payment plan. When the user is presented with the offer to enroll in the scheduled payment program/plan, the TAI computing environment 210 can also run or execute (435) the balance prediction model 340 and create a proposed payment schedule for the user including the proposed monthly balance amounts that the user is to pay if the user enrolls in the program.

Accordingly, in various embodiments, the balance prediction model 340 can predict a user's spending patterns over a specific period of time (e.g., an annual period) and resulting transaction account balance based on historical spends. Thus, the balance prediction model 340 can take into consideration how stable a user's transaction account balance is over time and can consider the types of the transactions the user has conducted over time in order to predict the user's future transaction account balance across different month groupings and create a payment schedule or plan for the user.

In various embodiments, each payment schedule is personalized or customized based on a predictable structure of a user's previous spending history and/or a history of the user's spending interests. As such, monthly payment amounts can be grouped, such that a same monthly payment amount can apply for a whole year or can apply for several consecutive months, where the grouping can be different for different users. As an example, a hypothetical user can pay a different payment amount for every two month grouping, where another user can pay a different payment amount for every three month grouping, where another user can pay a different payment amount for the first two months, the next four months, the next two months, and the next four months within a 12-month period, and another user can pay the same monthly amount throughout the whole year. Thus, a hypothetical month-to-month payment plan can be offered to a user at $2,500 per month for the first four months of the year, $2,400 per month for the second four months of the year, and $2, 100 per month for the last four months of the year, irrespective of how much the actual monthly spend is, which provides a structured plan for the user.

In various embodiments, for users that agree to be enrolled into the scheduled payment program/plan, the eligibility model can continue to monitor (440) the spending behavior of the user going forward to determine if the user's actual spending volatility is below a threshold value or level (or if the user's behavior fits into the low volatility category). Circumstances can arise where some users can try to take advantage of the scheduled payment program and intentionally make spending purchases that exceed the scheduled monthly payments causing their spend profile to change drastically from the time when they initially enrolled into program. In this case, the eligibility model engine 326 can trigger an alert signal or message to the TAI computing environment 210 when a user with a high variability of spending is not conforming with the predicted spending behavior for the user, such that the TAI computing environment 210 can unenroll the user from the scheduled payment plan.

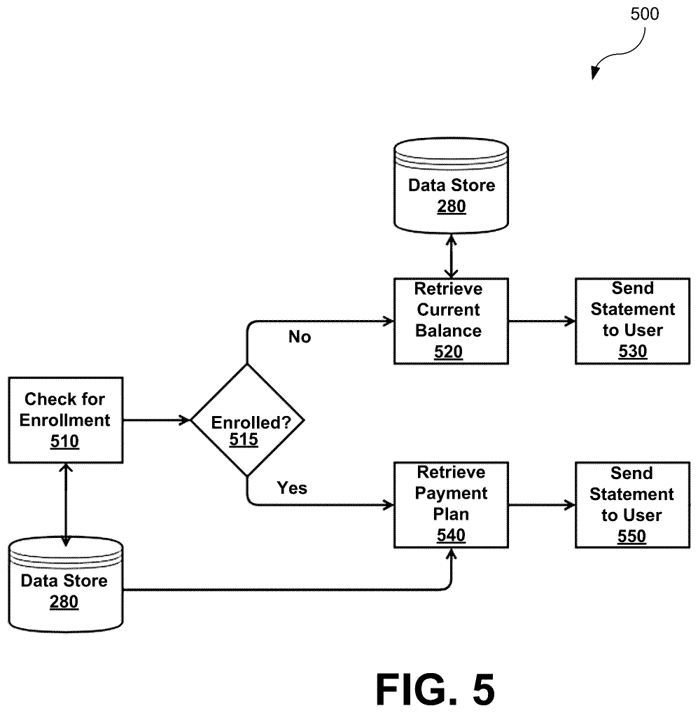

Referring now to FIG. 5, a flow chart illustrating an exemplary billing and account statement method 500 is presented. The method 500 can be implemented by a predictive spending and payment management system 200 described with reference to FIG. 2. Since various users of a transaction account issuer can be enrolled in the scheduled payment program/plan or not enrolled in the scheduled payment program/plan, the billing and account statement method starts with checking (510-515) if a user is enrolled in the scheduled payment program/plan. Accordingly, enrollment information can be retrieved from a data store 280, which stores information procured by a transaction account issuer that is relevant to a user of the transaction account issuer, such as transaction history, payment plan information, transaction account balance data, credit scores, user demographics, linked accounts, user relationships, etc.

If the user is not enrolled in the scheduled payment plan/program, the TAI computing environment 210 retrieves (520) a current balance of a transaction account of the user from the data store 280. As noted previously, the data store 280 can be located in a single installation or can be distributed among many different geographical locations.

The current transaction account balance information is then provided (530) as an account statement to the user (e.g., sent to the user via e-mail, physical mail, mobile application, or the Internet). For example, the TAI computing environment 210 can provide a graphical user interface (“GUI”), such as a web site or mobile application, which allows the user to interact with the TAI and view an account statement detailing the user's balance information and possibly make electronic payments. In various embodiments, the TAI computing environment 210 can communicate with the data store 280 in order to provide transaction account balance information to the user and process payments from the user.

Accordingly, if the user is enrolled in the scheduled payment plan/program, the TAI computing environment 210 retrieves (540) payment plan information for the user from the data store 280 that specifies a currently monthly amount that the user is scheduled to pay.

The current monthly amount that the user is scheduled to pay is then provided (550) as an account statement to the user (e.g., sent to the user via e-mail, physical mail, mobile application, or the Internet). So instead of sending a full account balance to the user as a billing statement, a separate billing statement is sent with the monthly scheduled amount that is specified in the scheduled payment plan/program for which the user is enrolled. For example, the TAI computing environment 210 can provide a graphical user interface (“GUI”), such as a web site or mobile application, which allows the user to interact with the TAI and view a statement detailing the user's balance information and possibly make electronic payments. Additionally, the statement can also show the current transaction account balance information for the user is more than or less than the scheduled current monthly amount and can show a balance of a user's savings account/contractual deposits (CD) and its available funds. In various embodiments, the TAI computing environment 210 can communicate with the data store 280 in order to provide payment plan information to the user and process scheduled payments from the user.

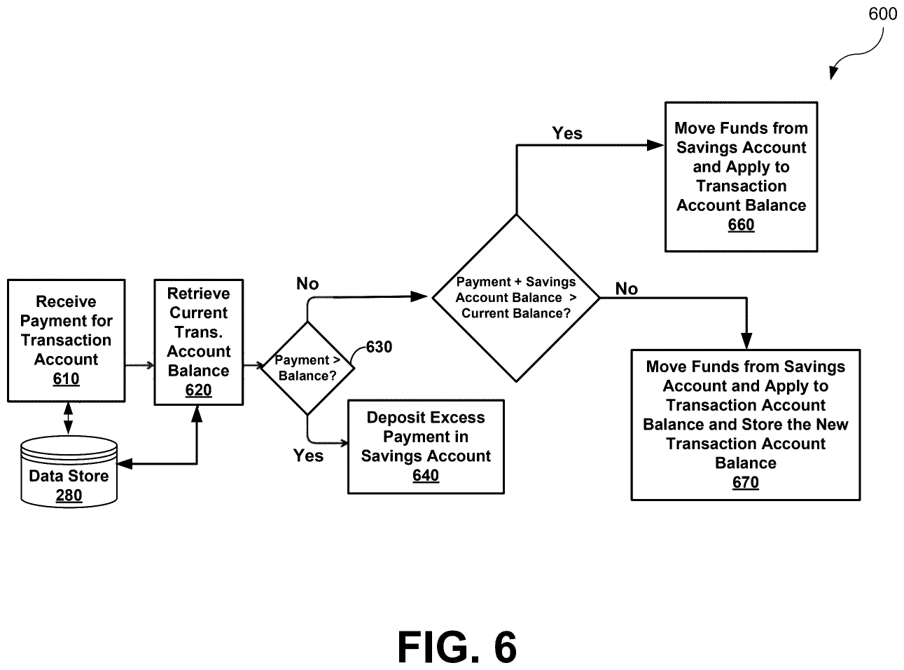

Referring now to FIG. 6, a flow chart illustrating an exemplary billing and payment deferral method 600 is presented. The method 600 can be implemented by a predictive spending and payment management system 200 described with reference to FIG. 2. While an enrolled user is scheduled to make a certain payment amount each month as part of an exemplary scheduled payment plan/program of the present disclosure, the user can elect to pay more than the scheduled payment amount or can spend less than the scheduled monthly payment. For example, a hypothetical user can know that the user's spending level for the next month(s) will be higher than usual, so the user can pay an amount than is required by the user's payment plan in order to plan for the increased spending. In this way, the excess payment will be applied to the user's savings account, where the savings account can receive a favorable interest payment while being deposited in the savings account, and the savings account balance will be available to cover for future account balances that exceed the user's scheduled monthly payments. Alternatively, if the user's actual monthly spending is less than the user's predicted monthly payment and corresponding scheduled monthly payment, the excess difference will also be applied to a savings account that can earn interest to the user's benefit. As an example, if an enrolled user makes a $2,100 monthly payment and the user has only spent $1,000 in that month, then $1,100 can be deposited in a savings account for the user and interest payments for which the user would not be entitled in a conventional transaction account payment process can be applied to the savings account.

Accordingly, under method 600, when a transaction account scheduled monthly payment is received (610) from a user by the TAI computing environment 210, the received payment is deposited in a data store 280. In various embodiments, the data store can store information procured by a transaction account issuer that is relevant to a user of the transaction account issuer, such as transaction history, transaction account balance data, credit scores, user demographics, linked accounts, user relationships, payment plan information, etc. In various embodiments, the data store 280 can be located in a single installation or can be distributed among many different geographical locations.

The TAI computing environment 210 (e.g., a plan management API 260 deployed by the TAI computing environment 210) can then retrieve (620) a current transaction account balance of the user for the transaction account from the data store 280, where the data store 280 stores account balance information for users of the transaction account issuer. The data store can also store, in addition to the account information, other user data, such as, but not limited to, transaction history, credit scores, user demographics, linked accounts, user relationships, payment plan information, etc. In various embodiments, the data store 280 can be located in a single installation or can be distributed among many different geographical locations. Alternatively, the account information can be stored separately from other user data, in various embodiments. Thus, after obtaining the current account balance information, the TAI computing environment 210 can determine (630) if the received monthly payment is greater than the current account balance for the user's transaction account.

For any excess payment, the TAI computing environment 210 (e.g., plan management API 260 of the TAI computing environment 210) can deposit (640) the excess payment in a savings accounts/contractual deposits arrangement with the transaction account issuer (or other financial institution) to route deferred funds into the savings account of the user where interest can be paid by the financial institution and the funds will be available to cover potential unanticipated/unplanned expenses and underpayments in other monthly periods.

For any payment shortage, the TAI computing environment 210 can determine (650) if there are sufficient funds in the savings account/contractual deposits (CD) arrangement for the scheduled payment plan/program that offset the difference between the current transaction account balance and a total of the received payment amount and the amount of funds in the user's savings account/contractual deposits.

If there are sufficient funds in the savings account/CD arrangement, then the necessary funds will be withdrawn (660) from the savings account/CD in order to move the funds and cover the difference between the current transaction account balance and the received payment amount. For example, if a user paid $2,000 in accordance with the user's scheduled payment plan and the spending amount for the corresponding amount is $2,300 (resulting in a shortage of $300) and the user has $1,000 in the user's savings account/CD, then $300 will be withdrawn from the user's savings account and applied to the user's transaction account balance, resulting in the user's savings account/CD balance becoming $700. Accordingly, a new balance for the savings account/CD can be computed and stored in the data store 280.

Otherwise, if there are insufficient funds in the savings account/CD arrangement to offset or cover the difference between the current transaction account balance and the received payment amount, any available funds in the savings account/CD can be withdrawn (by the TAI computing environment 210) and applied (670) to the user's transaction account balance. Accordingly, a new balance for the savings account/CD can also be computed and stored in the data store 280. However, in various embodiments, as long as the user pays the scheduled monthly balance of the scheduled payment plan, the user will not be charged any monthly finance charge as long as the user continues to make the aforementioned payment in subsequent statement periods and there is no outstanding shortage at the end of the annual period (or other set period).

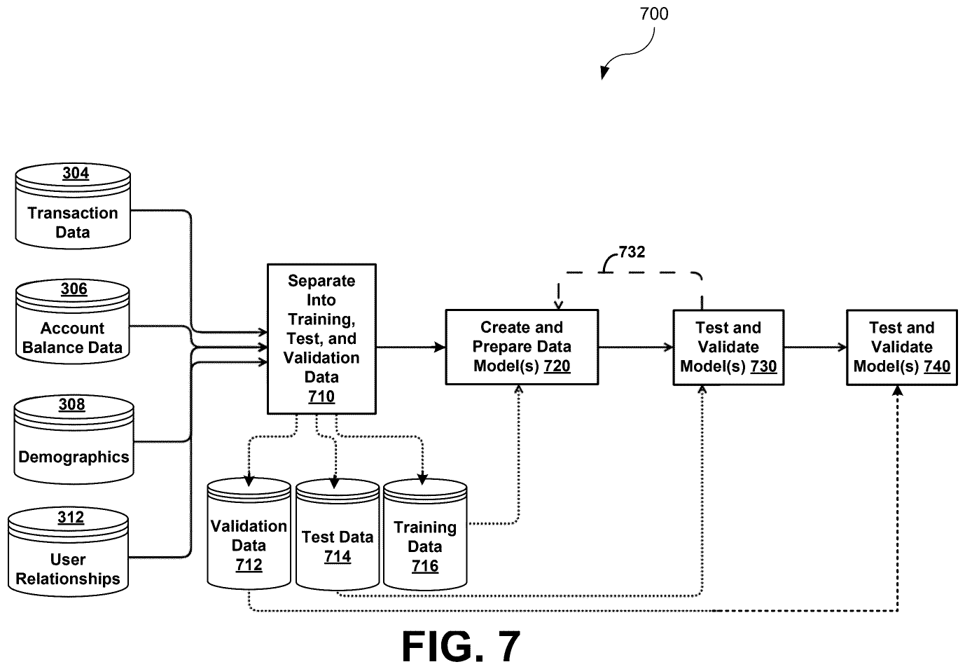

Referring now to FIG. 7, a flow chart illustrating an exemplary training method 700 is presented for the eligibility model 330 and/or the balance prediction model 340. The method 700 can be implemented by a predictive spending and payment management system 200, including the eligibility model engine 326 and/or balance prediction model engine 328, described with reference to FIG. 3. In order to train and prepare the eligibility model 330 and/or the balance prediction model 340, input data is separated or filtered (710) into training data 712, test data 714, and validation data 716 by the TAI computing environment 210. The input data comprises various user data, such as, but not limited to, transaction data 304, transaction account balance data 306, user demographics data 308, and user relationship data 312 that can be stored in the data store 280. In various embodiments, a user considered for the scheduled payment plan/program can have several years of data available to be used for modeling the user's eligibility and/or spending variability and/or spending volatility, such that the user data from over two years ago can be sorted into training data, user data from the previous year can be sorted into test data, and user data from a current year or ongoing years can be used as validation data.

Accordingly, with the training data, the eligibility model engine 326 and/or balance prediction model engine 328 can create and prepare (720) respective data models for a prospective user of the scheduled payment plan/program. In various embodiments, data models can be generated with user trends over time and variations in spend behavior by using transaction data, balances, demographics (e.g., user-location, gender, age, etc.). Depending upon the past balances and transactions, the eligibility and balance prediction data models are executed to identify if a user fits into a predictable payment plan.

After initial data models are created for a potential user and the potential user is identified as being a candidate for the scheduled payment plan/program, the TAI computing environment 210 can apply the test data of the user as inputs to validate and test (730) one or more of the data models and the output results can be used as feedback or closed-loop data to improve the model(s). Thus, the models can be created using the training data and executed over time with the test data to see how well the model works in predicting the user's spending behavior during a year from whence the test data was compiled. As such, by comparing predictive outputs of the models for year X and with actual performance data for year X, the corresponding deviation can be used to assess how well the models can be performing and if one or model parameters can need to be adjusted (e.g., changing model attribute weights) to improve their performance.

Correspondingly, after the user has enrolled in the scheduled payment plan/program, the TAI computing environment 210 can apply validation data as inputs to validate and test (740) the one or more data models, such that the output results can be used as feedback data 732 to improve the model(s) and/or to assess the user's fit into the scheduled payment plan/program. For example, in certain embodiments, user data reflecting the spending behavior of the user while enrolled in the scheduled payment plan is compiled as validation data and is used to determine if the user's actual spending variability conforms to predictions output by the eligibility model 330. When a user with a high variance of spending is not conforming with the predicted spending behavior for the user, the TAI computing environment 210 can unenroll the user from the scheduled payment program/plan, in various embodiments.

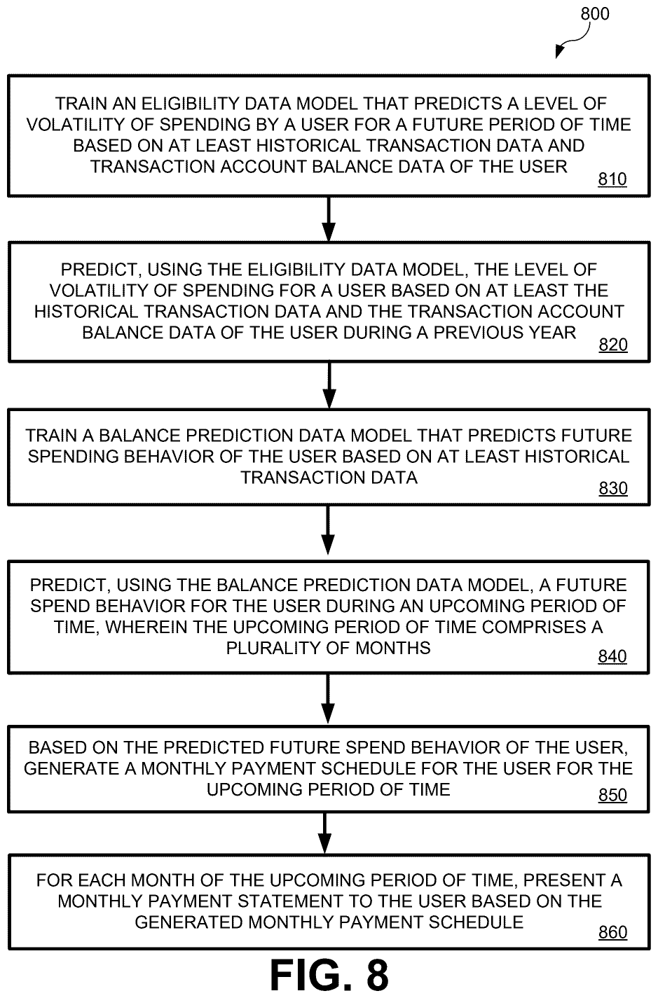

Referring now to FIG. 8, a flow chart illustrating an exemplary method 800 is presented for a predictive spending and payment management system 200. The method 800 includes training (810) an eligibility data model 330 that predicts a level of volatility of spending by a user for a future period of time based on at least historical transaction data and transaction account balance data of the user. Accordingly, with the training data, the eligibility data model engine 326 can create and prepare a eligibility data model for a prospective user of the scheduled payment plan/program. In various embodiments, such data models can be generated with user trends over time and variations in spend behavior by using transaction data, balances, demographics (e.g., user-location, gender, age, etc.).

Depending upon the past balances and transactions, the eligibility data model is executed to identify if a user fits into a predictable payment plan. Accordingly, the method 800 includes predicting (820), using the eligibility data model, the level of volatility of spending for a user based on at least the historical transaction data and the transaction account balance data of the user during a previous year. For example, the eligibility model 330 can analyze a user spend structure and profile preferences to identify if the user has a predictable spend structure. In various embodiments, the spending behavior of the user can be categorized as fitting or falling into a certain level of spending volatility, (e.g., such as categorizing the user's spend structure into a low, medium, or high level of volatility, where a high volatility corresponds to low predictability and vice versa). Thus, in various embodiments, users that fit in the low category can be presented with an offer to enroll in a scheduled payment plan for the upcoming year (or other set period of time) by the TAI computing environment 210 (e.g., account eligibility API 240 deployed by the TAI computing environment 210).

The method 800 further includes training (830) a balance prediction data model that predicts future spending behavior of the user based on at least historical transaction data. Accordingly, with the training data, the balance prediction data model engine 326 can create and prepare a balance prediction data model 340 for the prospective user of the scheduled payment plan/program. In various embodiments, such data models can be generated with user trends over time and variations in spend behavior by using transaction data, balances, demographics (e.g., user-location, gender, age, etc.).

Depending upon the past balances and transactions, the balance prediction data model 340 is executed to identify if a user fits into a predictable payment plan. Accordingly, the method 800 includes predicting (840), using the balance prediction data model, a future spend behavior for the user during an upcoming period of time, wherein the upcoming period of time comprises a plurality of months. In various embodiments, the balance prediction model 340 can predict a user's spending patterns or behaviors over a specific period of time (e.g., an annual period) and the resulting transaction account balance based on historical spends.

Based on the predicted future spend behavior of the user, a monthly payment schedule can be generated (850) for the user for the upcoming period of time. For example, the balance prediction model 340 can include a digitally constructed model that predicts a monthly payment schedule that will cover a user's actual spending during the defined period of time (e.g., upcoming 12-month period).

And then for each month of the upcoming period of time, a monthly payment statement can be issued or presented (860) to the user based on the generated monthly payment schedule. For example, the monthly payment statement can be provided as an account statement to the user (e.g., sent to the user via e-mail, physical mail, mobile application, or the Internet). So instead of sending a full account balance to the user as a billing statement, a separate billing statement can be sent with the monthly scheduled amount that is specified in the scheduled payment plan/program for which the user is enrolled.

The various system components discussed herein can include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein can include client data; merchant data; financial institution data; and/or like data useful in the operation of the system. As those skilled in the art will appreciate, user computer can include an operating system (e.g., WINDOWS®, UNIX®, LINUX®, SOLARIS®, MACOS®, etc.) as well as various conventional support software and drivers typically associated with computers.

The present system, or any part(s) or function(s) thereof, can be implemented using hardware, software, or a combination thereof and can be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations can be machine operations or any of the operations can be conducted or enhanced by artificial intelligence (AI) or machine learning. Artificial intelligence can refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, components, modules, and/or engines of system can be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app can be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app can leverage the communication protocol of the operating system and associated device hardware under the predetermined rules of the mobile operating system. Moreover, where the micro-app desires an input from a user, the micro-app can be configured to request a response from the operating system which monitors various hardware components and then communicates a detected input from the hardware to the micro-app.

In various embodiments, the system can implement middleware to provide software applications and services, and/or to bridge software components in the computer-based system, such as the operating system, database, applications, and the like. Middleware can include any hardware and/or software suitably configured to facilitate communications and/or process transactions between disparate computing systems. Middleware components are commercially available and known in the art. Middleware can be implemented through commercially available hardware and/or software, through custom hardware and/or software components, or through a combination thereof. Middleware can reside in a variety of configurations and can exist as a standalone system or can be a software component residing on the internet server. Middleware can be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

The systems, computers, computer-based systems, and the like disclosed herein can provide a suitable website or other internet-based graphical user interface which is accessible by users. Practitioners will appreciate that there are a number of methods for displaying data within a browser-based document. Data can be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein can be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server can include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services can provide one way of enabling interoperability between applications.

In various embodiments, the server can include application servers (e.g. WEBSPHERE®, WEBLOGIC®, JBOSS®, POSTGRES PLUS ADVANCED SERVER®, etc.). In various embodiments, the server can include web servers (e.g. Apache, IIS, GOOGLE® Web Server, SUN JAVA® System Web Server, JAVA® Virtual Machine running on LINUX® or WINDOWS® operating systems).

Users, systems, computer-based systems or the like can communicate with the server via a web client. The web client includes any device or software which communicates via any network such as, for example any device or software discussed herein. The web client can include internet browsing software installed within a computing unit or system to conduct online transactions and/or communications. These computing units or systems can take the form of a computer or set of computers, although other types of computing units or systems can be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client can include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client can also run MICROSOFT® EDGER software, MOZILLA® FIREFOX® software, GOOGLE® CHROME® software, APPLE® SAFARI® software, or any other of the myriad software packages available for browsing the internet.

As those skilled in the art will appreciate, the web client can or cannot be in direct contact with the server (e.g., application server, web server, etc., as discussed herein). For example, the web client can access the services of the server through another server and/or hardware component, which can have a direct or indirect connection to an internet server. For example, the web client can communicate with the server via a load balancer. In various embodiments, web client access is through a network or the internet through a commercially-available web-browser software package. In that regard, the web client can be in a home or business environment with access to the network or the internet. The web client can implement security protocols such as Secure Sockets Layer (SSL) and Transport Layer Security (TLS). A web client can implement several application layer protocols including HTTP, HTTPS, FTP, and SFTP.

Any databases (e.g., data stores) discussed herein can include relational, hierarchical, graphical, blockchain, object-oriented structure, and/or any other database configurations. Any database can also include a flat file structure wherein data can be stored in a single file in the form of rows and columns, with no structure for indexing and no structural relationships between records. For example, a flat file structure can include a delimited text file, a CSV (comma-separated values) file, and/or any other suitable flat file structure. Common database products that can be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database can be organized in any suitable manner, for example, as data tables or lookup tables. Each record can be a single file, a series of files, a linked series of data fields, or any other data structure.

Any database (e.g., data stores) discussed herein can comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger can use features and functionality of blockchain technology, including, for example, consensus-based validation, immutability, and cryptographically chained blocks of data. The blockchain can comprise a ledger of interconnected blocks containing data. The blockchain can provide enhanced security because each block can hold individual transactions and the results of any blockchain executables. Each block can link to the previous block and can include a timestamp. Blocks can be linked because each block can include the hash of the prior block in the blockchain. The linked blocks form a chain, with only one successor block allowed to link to one other predecessor block for a single chain. Forks can be possible where divergent chains are established from a previously uniform blockchain, though typically only one of the divergent chains will be maintained as the consensus chain. In various embodiments, the blockchain can implement smart contracts that enforce data workflows in a decentralized manner. The system can also include applications deployed on user devices such as, for example, computers, tablets, smartphones, Internet of Things devices (“IoT” devices), etc. The applications can communicate with the blockchain (e.g., directly or via a blockchain node) to transmit and retrieve data. In various embodiments, a governing organization or consortium can control access to data stored on the blockchain. Registration with the managing organization(s) can enable participation in the blockchain network.

The system can be embodied as a customization of an existing system, an add-on product, a processing apparatus executing upgraded software, a standalone system, a distributed system, a method, a data processing system, a device for data processing, and/or a computer program product. Accordingly, any portion of the system or a module can take the form of a processing apparatus executing code, an internet-based embodiment, an entirely hardware embodiment, or an embodiment combining aspects of the internet, software, and hardware. Furthermore, the system can take the form of a computer program product on a computer-readable storage medium having computer-readable program code means embodied in the storage medium. Any suitable computer-readable storage medium can be utilized, including hard disks, optical discs, magnetic discs, optical storage devices and media, magnetic storage devices and media, and/or the like.

Referring back to FIG. 2, TAI computing environment 210 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the TAI computing environment 210 can employ a plurality of computing devices that can be arranged in one or more server banks or computer banks or other arrangements. Such computing devices can be located in a single installation or can be distributed among many different geographical locations. For example, TAI computing environment 210 can include a plurality of computing devices that together can include a hosted computing resource, a grid computing resource or any other distributed computing arrangement. In some cases, TAI computing environment 210 can correspond to an elastic computing resource where the allotted capacity of processing, network, storage, or other computing-related resources can vary over time.

One or more processors of the TAI computing environment 210 can communicate with a number of peripheral devices via a data bus subsystem or interface. These peripheral devices can include a data subsystem (comprising a memory subsystem and file storage subsystem), user interface input devices, user interface output devices, and network interface subsystem.

Data bus subsystem can provide a mechanism that enables the various components and subsystems of TAI computing environment 210 to communicate with each other as intended. Network interface subsystem can serve as an interface for communicating data between TAI computing environment 210 and other computer systems or networks; e.g., nodes in a blockchain network. Embodiments of network interface subsystem can include, e.g., an Ethernet card, a Wi-Fi and/or cellular adapter, digital subscriber line (DSL) units, and/or the like.

User interface input devices can include a keyboard, pointing devices (e.g., mouse, trackball, touchpad, etc.), a touchscreen incorporated into a display, audio input devices (e.g., voice recognition systems, microphones, etc.) and other types of input devices. In general, use of the term “input device” is intended to include all possible types of devices and mechanisms for inputting information into TAI computing environment 210.

User interface output devices can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from TAI computing environment 210.

Data subsystem includes memory subsystem and file/disk storage subsystem representing non-transitory computer-readable storage media that can store program code and/or data, which when executed by the one or more processors, can cause the processor to perform operations in accordance with embodiments of the present disclosure.

Memory subsystem can include a number of memories including main random access memory (RAM) for storage of instructions and data during program execution and read-only memory (ROM) in which fixed instructions are stored. File storage subsystem can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art. Memory can include both volatile and nonvolatile memory and data storage components.

In addition, a processor can represent multiple processors and/or multiple processor cores, and the one or more memory devices can represent multiple memories that operate in parallel processing circuits, respectively. In such a case, a local interface can be an appropriate network that facilitates communication between any two of the multiple processors or between any processor and any of the memory devices. The local interface can include additional systems designed to coordinate this communication, including, for example, performing load balancing. The processor can be electric or of some other available construction.

It should be appreciated that the disclosed computer system arrangements for the TAI computing environment 210 are illustrative and many other configurations having more or fewer components are possible. These and other variations, modifications, additions, and improvements can fall within the scope of the appended claims(s). As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The flow chart diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flow chart diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flow chart diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
train an eligibility data model that predicts a level of volatility of spending by a user for a future period of time based on at least historical transaction data and transaction account balance data of the user;
predict, using the eligibility data model, the level of volatility of spending for a user based on at least the historical transaction data and the transaction account balance data of the user during a previous year;
train a balance prediction data model that predicts future spending behavior of the user based on at least historical transaction data;
predict, using the balance prediction data model, a future spend behavior for the user during an upcoming period of time, wherein the upcoming period of time comprises a plurality of months;
generate a monthly payment schedule for the user for the upcoming period of time based on the predicted future spend behavior of the user; and
for each month of the upcoming period of time, issue a monthly payment statement to the user based on the generated monthly payment schedule.

2. The system of claim 1, wherein the machine-readable instructions further cause the computing device to:
compare the predicted future spend behavior of the user for the upcoming period of time with an actual spend behavior of the user during the upcoming period of time;
determine that the actual spend behavior is not in conformance with the predicted future spend behavior based on the comparison of the predicted future spend behavior with the actual spend behavior of the user; and
adjust the monthly payment schedule so that the actual spend behavior conforms to the adjusted monthly payment schedule.

3. The system of claim 2, wherein the determination that the actual spend behavior is not in conformance with the predicted future spend behavior comprises determining that an actual spending volatility level of the user is below a threshold level.

4. The system of claim 1, wherein the historical transaction data comprises purchases made using a transaction account of the user and the transaction account balance data comprises historical balance information of the transaction account of the user.

5. The system of claim 1, wherein the prediction of the level of volatility of spending for the user comprises computing a score for the volatility of spending for the user and comparing the score against a threshold value.

6. The system of claim 1, wherein the generation of the monthly payment schedule for the user for the upcoming period of time comprises evaluating types of transactions that the user has conducted over time in order to predict a future transaction account balance of the user across different month groupings.

7. The system of claim 1, wherein the machine-readable instructions further cause the computing device to deposit an excess amount provided with the monthly payment statement to a savings account of the user.

8. The system of claim 7, wherein the machine-readable instructions further cause the computing device to apply funds from the savings account of the user to offset a difference between a current transaction account balance and a received payment amount for the monthly payment statement.

9. A method comprising:
predicting, by one or more computing devices using an eligibility data model, a level of volatility of spending for a user based on at least transaction data and transaction account balance data of the user during a previous year;
predicting, by the one or more computing devices using a balance prediction data model, a future spend behavior for the user during an upcoming period of time, wherein the upcoming period of time comprises a plurality of months;
generating, by the one or more computing devices, a monthly payment schedule for the user for the upcoming period of time based on the predicted future spend behavior of the user; and
for each month of the upcoming period of time, issuing, by the one or more computing devices, a monthly payment statement to the user based on the generated monthly payment schedule.

10. The method of claim 9, further comprising:
training, by the one or more computing devices, the eligibility data model based on at least historical transaction data and historical transaction account balance data of the user; and
applying, by the one or more computing devices, test transaction data of the user as an input to the eligibility data model to validate a performance of the eligibility data model, wherein the test transaction data is not used to train the eligibility data model.

11. The method of claim 9, further comprising:
training, by the one or more computing devices, the balance prediction data model based on at least historical transaction data and historical transaction account balance data of the user; and
applying, by the one or more computing devices, test transaction data of the user as an input to the eligibility data model to validate a performance of the eligibility data model wherein the test transaction data is not used to train the balance prediction data model.

12. The method of claim 9, further comprising:
comparing, by the one or more computing devices, the predicted future spend behavior of the user for the upcoming period of time with an actual spend behavior of the user during the upcoming period of time;
determining, by the one or more computing devices, that the actual spend behavior is not in conformance with the predicted future spend behavior based on the comparison of the predicted future spend behavior with the actual spend behavior of the user; and
adjusting, by the one or more computing devices, the monthly payment schedule so that the actual spend behavior conforms to the adjusted monthly payment schedule.

13. The method of claim 12, wherein the determination that the actual spend behavior is not in conformance with the predicted futures spend behavior comprises determining that an actual spending volatility level of the user is below a threshold level.

14. The method of claim 9, wherein the prediction of the level of volatility of spending for the user comprises computing a score for the volatility of spending for the user and comparing the score against a threshold value.

15. The method of claim 9, wherein the generation of the monthly payment schedule for the user for the upcoming period of time comprises evaluating types of transactions that the user has conducted over time in order to predict a future transaction account balance of the user across different month groupings.

16. The method of claim 9, wherein the machine-readable instructions further cause the one or more computing devices to deposit an excess amount provided with the monthly payment statement to a savings account of the user.

17. The method of claim 16, wherein the machine-readable instructions further cause the computing device to apply funds from the savings account of the user to offset a difference between a current transaction account balance and a received payment amount for the monthly payment statement.

18. A non-transitory, computer-readable medium comprising machine-readable instructions that, when executed by a processor of a computing device, cause the computing device to at least:
predict, using an eligibility data model, a level of volatility of spending for a user based on at least transaction data and transaction account balance data of the user during a previous year;
predict, using a balance prediction data model, a future spend behavior for the user during an upcoming period of time, wherein the upcoming period of time comprises a plurality of months;
generate a monthly payment schedule for the user for the upcoming period of time based on the predicted future spend behavior of the user; and
for each month of the upcoming period of time, issue a monthly payment statement to the user based on the generated monthly payment schedule.

19. The non-transitory, computer-readable medium of claim 18, wherein the machine-readable instructions further cause the computing device to train the eligibility data model based on at least historical transaction data and historical transaction account balance data of the user.

20. The non-transitory, computer-readable medium of claim 18, wherein the machine-readable instructions further cause the computing device to train the balance prediction data model based on at least historical transaction data and historical transaction account balance data of the user.
